(19) United States
(12) Patent Application Publication
(10) Pub. No.: US 2020/0044592 A1
(43) Pub. Date: Feb. 6, 2020

(54) MOTOR DRIVING METHOD, TERMINAL DEVICE, AND COMPUTER-READABLE STORAGE MEDIUM

(71) Applicant: AAC Technologies Pte. Ltd., Singapore city (SG)

(72) Inventors: Jianqi Li, Shenzhen (CN); Yulei Zhang, Shenzhen (CN); Xiaojie Shao, Shenzhen (CN); Xiang Ding, Shenzhen (CN)

(21) Appl. No.: 16/528,679

(22) Filed: Aug. 1, 2019

(30) Foreign Application Priority Data
Aug. 6, 2018 (CN) 201810883838.8

(51) Int. Cl. H02P 25/032; H02P 23/00; G08B 6/00

(52) U.S. Cl. CPC H02P 25/032; G08B 6/00; H02P 23/0077

(57) ABSTRACT

In the field of mobile devices, a motor driving method, a terminal device, and a computer-readable storage medium are disclosed. In the present disclosure, a current state of an application target in a current running program is obtained in real-time, a drive signal is generated according to the current state of the application target and is used to drive a motor to produce a vibration sensation corresponding to the current state, and the motor is driven to vibrate according to the generated drive signal. In this way, the motor vibration can be dynamically changed in real time as the use scenario of the mobile terminal changes.

### TECHNICAL FIELD

Embodiments of the present disclosure relate to the field of mobile devices, and in particular, to a motor driving method, a terminal device, and a computer-readable storage medium.

### BACKGROUND

Motors provide tactile experience to users, and good vibration feedback can bring different product experience to users. Currently, motors on the market have been widely applied to products, and mostly can meet the requirements of users. Use of a motor in a mobile terminal to enhance user experience has been a widely used technical means.

The inventor finds that the existing technology has at least the following problem: most of existing motors vibrate according to a preset vibration state, and the vibration cannot be dynamically changed according to specific scenarios.

### BRIEF DESCRIPTION OF THE DRAWINGS

FIG. 1 is a flowchart of a motor driving method according to a first embodiment of the present disclosure;

FIG. 2 is a flowchart of a motor driving method according to a second embodiment of the present disclosure; and

FIG. 3 is a schematic diagram of a terminal device according to a third embodiment of the present disclosure.

### DETAILED DESCRIPTION

To make the objectives, technical solutions, and advantages of the embodiments of the present disclosure clearer, the following further describes embodiments of the present disclosure in detail with reference to the accompanying drawings. However, those of ordinary skill in the art may understand that, in the various embodiments of the present disclosure, numerous technical details are set forth to provide the reader with a better understanding of the present disclosure. However, the technical solutions claimed in the present disclosure can further be implemented without these technical details and various changes and modifications based on the following embodiments.

A first embodiment of the present disclosure relates to a motor driving method. The core of this embodiment is to obtain in real-time a current state of an application target in a current running program; generate, according to the current state of the application target, a drive signal used to drive a motor to produce a vibration sensation corresponding to the current state; and drive the motor to vibrate according to the generated drive signal. In this way, the motor vibration can be dynamically changed in real time as the use scenario of the device changes. Implementation details of the motor driving method of this embodiment will be specifically described below. The following content is merely implementation details provided for convenience of understanding, and is not necessary for implementing this solution.

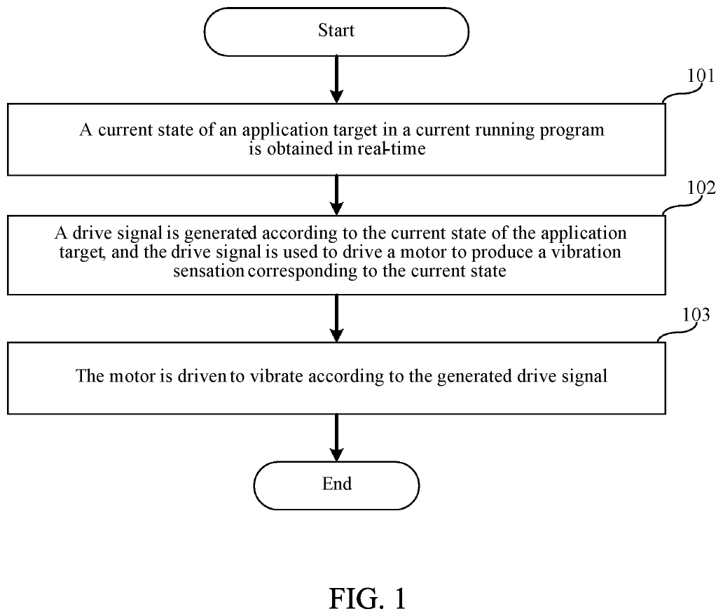

As shown in FIG. 1, the motor driving method according to this embodiment specifically includes the following steps:

Step 101, a current state of an application target in a current running program is obtained in real-time.

Specifically, the motor driving method is applicable to various mobile terminals such as mobile phones and tablet computers. A current application program on a mobile terminal may have various application targets. For example, if a little ball is in the current application program, the little ball may be set as the application target. For another example, when the current application program is a driving game, the application target may be a vehicle.

The application target of the current running program has status information, and the current state of the application target may include one or a combination of the following: a movement speed of the application target and a shaking amplitude of the application target. For example, when the application target is a little ball, the little ball has status information such as a movement speed, a size of the little ball, and an amplitude of bouncing up and down. When the application target is a vehicle, the vehicle has status information such as a movement speed and a shaking amplitude. The mobile terminal can obtain the status information of the application target in the current program.

Step 102, a drive signal is generated according to the current state of the application target. Herein, the drive signal is used to drive a motor to produce a vibration sensation corresponding to the current state.

Specifically, the drive signal used to drive the motor is generated according to the current state of the application target, and a correspondence relationship exists between the drive signal and the state of the application target. A method for generating the drive signal used to drive the motor to produce the vibration sensation corresponding to the current state may be: determining, according to the current state of the application target, a parameter associated with a vibration sensation corresponding to the current state; and generating, according to the parameter associated with a vibration sensation, the drive signal used to drive the motor to produce the vibration sensation corresponding to the current state.

That is, after the state of the application target in the current running program is obtained, the parameter associated with a vibration sensation of the drive signal to be sent is adjusted according to the state of the application target. The drive signal is generated according to the related parameter and sent to drive the motor to vibrate. In other words, the state of the application target influences the state of the drive signal. The parameter associated with a vibration sensation of the drive signal includes: a signal amplitude and/or a signal interval.

A method for generating the drive signal used to drive the motor to produce the vibration sensation corresponding to the current state may alternatively be: determining, according to the current state of the application target and a preset correspondence relationship between target states and expected vibration sensation, an expected vibration sensation corresponding to the current state; and obtaining, according to the determined expected vibration sensation and a preset correspondence relationship between drive signals and expected vibration sensation, a drive signal corresponding to the determined expected vibration sensation. That is, a correspondence relationship between the current state of the application target and a motor vibration sensation and a preset correspondence relationship between drive signals and expected vibration sensation are preset on the terminal device. For example, there is a correspondence relationship between different current movement speeds of the application target and different motor vibration sensation, and there is a correspondence relationship between different current shaking amplitudes of the application target and different motor vibration sensation. When the current state of the application target is obtained, the expected vibration sensation of the motor is first obtained according to the current state, then parameters of the drive signal such as the amplitude and the interval of the drive signal are derived from the expected vibration sensation, and afterwards the drive signal used to drive the motor to reach the expected vibration sensation is obtained according to the parameters. According to the obtained current state of the application target and the preset correspondence relationship, the expected vibration of the motor when the application target is in the current state can be easily obtained. The drive signal corresponding to the determined expected vibration sensation can be obtained according to the expected vibration sensation of the motor, so as to drive the motor to reach the expected vibration sensation, thereby ensuring user experience.

For example, in example 1, when the obtained state of the application target is specifically the movement speed of the application target in the current running program (e.g., the movement speed of the little ball in the application program), the step of determining the state of the drive signal according to the state of the application target specifically includes: determining the amplitude of the drive signal according to the movement speed of the application target. In this case, the amplitude of the drive signal is influenced by the movement speed of the application target. For example, the higher the movement speed of the little ball is, the larger the amplitude of the drive signal is.

In example 2, when the obtained state of the application target is specifically the movement speed of the application target in the current running program, the step of determining the state of the drive signal according to the state of the application target specifically includes: determining the interval of the drive signal according to the movement speed of the application target. In this case, the interval of the drive signal is influenced by the movement speed of the application target. For example, the higher the movement speed of the little ball is, the shorter the interval of the drive signal is.

In example 3, when the obtained state of the application target is specifically the shaking amplitude of the application target in the current running program, the step of determining the state of the drive signal according to the state of the application target specifically includes: determining the amplitude of the drive signal according to the shaking amplitude of the application target. In this case, the amplitude of the drive signal is influenced by the shaking amplitude of the application target.

In example 4, when the obtained state of the application target is specifically the shaking amplitude of the application target in the current running program, the step of determining the state of the drive signal according to the state of the application target specifically includes: determining the interval of the drive signal according to the shaking amplitude of the application target. In this case, the interval of the drive signal is influenced by the shaking amplitude of the application target.

Step 103, the motor is driven to vibrate according to the generated drive signal.

Specifically, the motor is driven by an electrical signal, a waveform of the electrical signal directly determines the vibration effect of the motor. Control of the motor vibration can be achieved by changing a parameter of the electrical signal. During the process of driving the motor to vibrate, parameters such as an amplitude of the signal and an interval between unit signals may be changed to change the vibration state of the motor.

For example, in example 1, when the obtained state of the application target is specifically the movement speed of the application target in the current running program, the step of determining the drive signal according to the state of the application target specifically includes: determining the amplitude of the drive signal according to the movement speed of the application target. In this case, the amplitude of the drive signal is influenced by the movement speed of the application target, so that the intensity of the motor vibration is changed as the speed of the application target changes. The higher the speed is, the stronger the vibration is.

In example 2, when the obtained state of the application target is specifically the movement speed of the application target in the current running program, the step of determining the drive signal according to the state of the application target specifically includes: determining the interval of the drive signal according to the movement speed of the application target. In this case, the interval of the drive signal is influenced by the movement speed of the application target, so that the frequency of the motor vibration is changed as the speed of the application target changes. The higher the speed is, the higher the vibration frequency is.

In example 3, when the obtained state of the application target is specifically the shaking amplitude of the application target in the current running program, the step of determining the drive signal according to the state of the application target specifically includes: determining the amplitude of the drive signal according to the shaking amplitude of the application target. In this case, the amplitude of the drive signal is influenced by the shaking amplitude of the application target, so that the intensity of the motor vibration is changed as the shaking amplitude of the application target changes. The larger the shaking amplitude is, the stronger the vibration is.

In example 4, when the obtained state of the application target is specifically the shaking amplitude of the application target in the current running program, the step of determining the drive signal according to the state of the application target specifically includes: determining the interval of the drive signal according to the shaking amplitude of the application target. In this case, the interval of the drive signal is influenced by the shaking amplitude of the application target, so that the frequency of the motor vibration is changed as the shaking amplitude of the application target changes. The larger the shaking amplitude is, the higher the vibration frequency is.

Compared with the existing technology, in this embodiment, a state of an application target in a current running program is obtained, a state of a drive signal used to drive a motor to vibrate is determined according to the state of the application target, and the drive signal is sent to the motor so that the motor determines a vibration state according to the state of the drive signal. In this way, the motor vibration can be dynamically changed in real time as the use scenario of the mobile terminal changes.

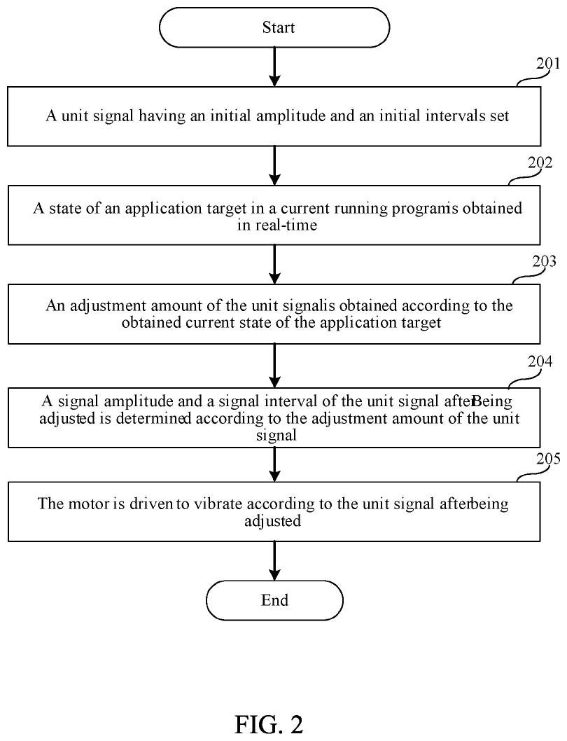

A second embodiment of the present disclosure relates to a motor driving method. This embodiment is an improvement on the first embodiment. The improvement lies in that in this embodiment, before obtaining in real time a current state of an application target in a current running program, a unit signal having an initial amplitude and an initial interval is set; the step of generating a drive signal used to drive a motor to produce a vibration sensation corresponding to the current state specifically includes: obtaining, according to the obtained current state of the application target, an adjustment amount of the unit signal; determining, according to the adjustment amount of the unit signal, a signal amplitude and a signal interval of the unit signal after being adjusted; and the step of driving the motor to vibrate according to the generated drive signal specifically includes: driving the motor to vibrate according to the unit signal after being adjusted. FIG. 2 is a flowchart of the method, including the following steps:

Step 201, a unit signal having an initial amplitude and an initial interval is set.

Specifically, a specific method for determining a state of a drive signal according to a state of an application target may be setting a unit signal in the drive signal. That is, the drive signal is composed of the unit signal, and the state of the unit signal sent each time is determined by the state of the application target. Therefore, the unit signal sent each time may change as the state of the application target changes. Because the motor is driven by the drive signal, the motor changes its vibration state when the received unit signal changes.

The unit signal may be any signal waveform such as a sine wave, and the state of the unit signal is determined according to the state of the application target. That is, in time domain, what time period in the sent drive signal may be set as a unit time domain, and then the unit signal to be sent each time is set according to the unit time domain. The drive signal is composed of the unit signal sent periodically. In this embodiment, the initial amplitude and the initial interval are preset for the unit signal. After the unit signal is set with the initial amplitude and the initial interval, the unit signal may not be sent until the state of the application target in the current running program is detected.

Step 202, a state of an application target in a current running program is obtained in real-time. Because step 202 in this embodiment and step 101 in the first embodiment are basically the same, the details are not described herein again.

Step 203, an adjustment amount of the unit signal is obtained according to the obtained current state of the application target;

Specifically, because the initial amplitude and the initial interval are set for the unit signal, the vibration state of the motor needs to be adjusted to reach an expected vibration when the current state of the application target is obtained. Therefore, the unit signal used to drive the motor needs to be adjusted to change the amplitude of the unit signal, or to change the interval of the unit signal, or to change both the amplitude and the interval of the unit signal. Therefore, the adjustment amount of the unit signal needs to be obtained according to the obtained current state of the application target, so as to make the adjustment of the unit signal more convenient.

Step 204, a signal amplitude and a signal interval of the unit signal after being adjusted is determined according to the adjustment amount of the unit signal;

Specifically, after the adjustment amount of the unit signal is obtained, the signal amplitude and the signal interval of the unit signal are adjusted, so that the unit signal after being adjusted can drive the motor to reach the expected vibration.

The following is an example of the process of using the unit signal to drive the motor. For the unit signal, the initial intensity may be set to be 100% and the initial interval may be set to be 0 ms. Then the unit signal is sent to drive the motor to start vibrating. The process is repeated by using the unit signal as the period and based on the intensity of 100%. As the state of the application target is changed, the intensity of the unit signal is changed to 60%, and the interval is changed to 50 ms. That is, in this case, by using the unit signal plus the interval of 50 ms as the period, the unit signal having the intensity 60% is sent repeatedly to the motor to change the vibration state of the motor. When the motor stops vibrating, the amplitude percentage and the interval of the unit signal may be randomly changed according to the state of the application target, so as to cause the vibration state of the motor to change correspondingly.

In the embodiment, the method of generating the unit signal according to the current state of the application target is adjusting the signal amplitude and the signal interval of the unit signal according to the obtained current state of the application target to obtain the unit signal that can drive the motor to reach the expected vibration. In practice, the method of generating the unit signal according to the current state of the application target may alternatively be directly calculating, according to the obtained current state of the application target, the signal amplitude and the signal interval of the unit signal that can drive the motor to reach the expected vibration and generating the unit signal, without setting the signal amplitude and the signal interval of the unit signal. The details are not described herein.

Step 205, the motor is driven to vibrate according to the unit signal after being adjusted.

Compared with the existing technology, in this embodiment, a unit signal having an initial amplitude and an initial interval is set, a state of an application target in a current running program is obtained in real time, an adjustment amount of the unit signal is obtained according to the obtained current state of the application target, a signal amplitude and a signal interval of the unit signal after being adjusted are determined according to the adjustment amount, and a motor is driven to vibrate by the unit signal after being adjusted. In this way, the drive signal can be adjusted into a signal that can drive the motor to reach an expected vibration, and the motor vibration can be dynamically changed in real time more conveniently according to the use scenario of the mobile terminal.

The foregoing division of the method into steps is merely for the purpose of description. During implementation, several steps may be combined into one step or one step may be decomposed into a plurality of steps, as long as the same logical relationship is included, and such combination and decomposition shall fall within the protection scope of the present disclosure. Any insignificant modification or design introduced to the algorithm or process without changing the core design of the algorithm and process shall fall within the protection scope of the present disclosure.

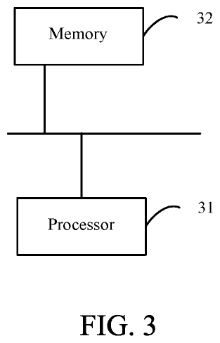

A third embodiment of the present disclosure relates to a terminal device, as shown in FIG. 3, including at least one processor 31 and a memory 32 communicably connected with the at least one processor 31. Herein, the memory 32 is configured to store instructions executable by the at least one processor 31. Execution of the instructions by the at least one processor 31 causes the at least one processor 31 to perform the motor driving method according to the first embodiment of the present disclosure or the second embodiment of the present disclosure.

The memory 32 and the processor 31 are connected via a bus. The bus may include any quantity of interconnected buses and bridges. The bus connects various circuits of the one or more processors 31 and the memory 32. The bus may also connect various other circuits such as a peripheral device, a voltage regulator, and a power management circuit. These are known in the art, and the details are not described herein. A bus interface provides an interface between the bus and a transceiver. The transceiver may be one element or a plurality of elements such as a plurality of receivers and transmitters, and serves as a unit configured to communicate with various other devices over a transmission medium. Data processed by the processor 31 is transmitted over a wireless medium by using an antenna. The antenna further receives data and transmits the data to the processor 31.

The processor 31 is responsible for managing the bus and general processing, and may further provide various functions including timing, peripheral interface, voltage adjustment, power supply management, and other control functions. The memory 32 may be configured to store data used by the processor 31 executing an operation.

A fourth embodiment of the present disclosure relates to a computer-readable storage medium storing a computer program. The foregoing method embodiment is implemented when the computer program is executed by a processor.

That is, those skilled in the art may understand that all or some of the steps in the methods according to the foregoing embodiments may be implemented by a program instructing relevant hardware. The program is stored in a storage medium and includes instructions used to enable a device (which may be a single-chip microcomputer, a chip, or the like) or a processor to implement all or some of the steps in the methods according to the foregoing embodiments of the present disclosure. The storage medium includes any medium that can store program code, such as a USB flash memory drive, a removable hard disk, a read-only memory (ROM), a random access memory (RAM), a magnetic disk, or an optical disc.

Those of ordinary skill in the art may understand that, the embodiments described above are specific embodiments for implementing the present disclosure, and in actual applications, various changes of the forms and details may be made without departing from the spirit and scope of the present disclosure.

What is claimed is:

1. A motor driving method, applicable to a terminal device, and comprising:
obtaining in real-time a current state of an application target in a current running program;
generating, according to the current state of the application target, a drive signal used to drive a motor to produce a vibration sensation corresponding to the current state; and
driving the motor to vibrate according to the generated drive signal.

2. The motor driving method according to claim 1, wherein the generating a drive signal used to drive a motor to produce a vibration corresponding to the current state specifically comprises:
determining, according to the current state of the application target, a parameter associated with a vibration sensation corresponding to the current state; and
generating, according to the parameter associated with a vibration sensation, the drive signal used to drive the motor to produce the vibration sensation corresponding to the current state.

3. The motor driving method according to claim 2, wherein the parameter associated with a vibration sensation comprises a signal amplitude and/or a signal interval.

4. The motor driving method according to claim 3, further comprising:
setting, before obtaining in real time the current state of the application target in the current running program, a unit signal having an initial amplitude and an initial interval, wherein
the generating a drive signal used to drive a motor to produce a vibration sensation corresponding to the current state, specifically comprises:
obtaining, according to the obtained current state of the application target, an adjustment amount of the unit signal;
determining, according to the adjustment amount, a signal amplitude and a signal interval of the unit signal after being adjusted; and
the driving the motor to vibrate according to the generated drive signal specifically comprises:
driving the motor to vibrate according to the unit signal after being adjusted.

5. The motor driving method according to claim 1, wherein the generating, according to the current state of the application target, a drive signal used to drive a motor to produce a vibration sensation corresponding to the current state, specifically comprises:
determining, according to the current state of the application target and a preset correspondence relationship between target states and expected vibration sensation, an expected vibration sensation corresponding to the current state; and
obtaining, according to the determined expected vibration sensation and a preset correspondence relationship between drive signals and expected vibration sensation, a drive signal corresponding to the determined expected vibration sensation.

6. The motor driving method according to claim 1, wherein the current state of the application target comprises one or a combination of:
a movement speed of the application target, and a shaking amplitude of the application target.

7. A terminal device, comprising:
at least one processor; and
a memory communicably connected with the at least one processor;
wherein the memory is configured to store instructions executable by the at least one processor,
wherein execution of the instructions by the at least one processor causes the at least one processor to perform a motor driving method;
wherein the motor driving method comprises:
obtaining in real-time a current state of an application target in a current running program;
generating, according to the current state of the application target, a drive signal used to drive a motor to produce a vibration sensation corresponding to the current state; and
driving the motor to vibrate according to the generated drive signal.

8. The terminal device according to claim 7, wherein the generating a drive signal used to drive a motor to produce a vibration corresponding to the current state specifically comprises:
determining, according to the current state of the application target, a parameter associated with a vibration sensation corresponding to the current state; and
generating, according to the parameter associated with a vibration sensation, the drive signal used to drive the motor to produce the vibration sensation corresponding to the current state.

9. The terminal device according to claim 8, wherein the parameter associated with a vibration sensation comprises a signal amplitude and/or a signal interval.

10. The terminal device according to claim 9, wherein the method further comprising:
setting, before obtaining in real time the current state of the application target in the current running program, a unit signal having an initial amplitude and an initial interval, wherein
the generating a drive signal used to drive a motor to produce a vibration sensation corresponding to the current state, specifically comprises:
obtaining, according to the obtained current state of the application target, an adjustment amount of the unit signal;
determining, according to the adjustment amount, a signal amplitude and a signal interval of the unit signal after being adjusted; and
the driving the motor to vibrate according to the generated drive signal specifically comprises:
driving the motor to vibrate according to the unit signal after being adjusted.

11. The terminal device according to claim 7, wherein the generating, according to the current state of the application target, a drive signal used to drive a motor to produce a vibration sensation corresponding to the current state, specifically comprises:
determining, according to the current state of the application target and a preset correspondence relationship between target states and expected vibration sensation, an expected vibration sensation corresponding to the current state; and
obtaining, according to the determined expected vibration sensation and a preset correspondence relationship between drive signals and expected vibration sensation, a drive signal corresponding to the determined expected vibration sensation.

12. The terminal device according to claim 7, wherein the current state of the application target comprises one or a combination of:
a movement speed of the application target, and a shaking amplitude of the application target.

13. A computer-readable storage medium storing a computer program, wherein when the computer program is executed by a processor, a motor driving method is implemented;
wherein the motor driving method comprises:
obtaining in real-time a current state of an application target in a current running program;
generating, according to the current state of the application target, a drive signal used to drive a motor to produce a vibration sensation corresponding to the current state; and
driving the motor to vibrate according to the generated drive signal.

14. The computer-readable storage medium according to claim 13, wherein the generating a drive signal used to drive a motor to produce a vibration corresponding to the current state specifically comprises:
determining, according to the current state of the application target, a parameter associated with a vibration sensation corresponding to the current state; and
generating, according to the parameter associated with a vibration sensation, the drive signal used to drive the motor to produce the vibration sensation corresponding to the current state.

15. The computer-readable storage medium according to claim 14, wherein the parameter associated with a vibration sensation comprises a signal amplitude and/or a signal interval.

16. The computer-readable storage medium according to claim 15, wherein the method further comprising:
setting, before obtaining in real time the current state of the application target in the current running program, a unit signal having an initial amplitude and an initial interval, wherein
the generating a drive signal used to drive a motor to produce a vibration sensation corresponding to the current state, specifically comprises:
obtaining, according to the obtained current state of the application target, an adjustment amount of the unit signal;
determining, according to the adjustment amount, a signal amplitude and a signal interval of the unit signal after being adjusted; and
the driving the motor to vibrate according to the generated drive signal specifically comprises:
driving the motor to vibrate according to the unit signal after being adjusted.

17. The computer-readable storage medium according to claim 13, wherein the generating, according to the current state of the application target, a drive signal used to drive a motor to produce a vibration sensation corresponding to the current state, specifically comprises:
determining, according to the current state of the application target and a preset correspondence relationship between target states and expected vibration sensation, an expected vibration sensation corresponding to the current state; and
obtaining, according to the determined expected vibration sensation and a preset correspondence relationship between drive signals and expected vibration sensation, a drive signal corresponding to the determined expected vibration sensation.

18. The computer-readable storage medium according to claim 13, wherein the current state of the application target comprises one or a combination of:
a movement speed of the application target, and a shaking amplitude of the application target.
